(19) United States
(12) Patent Application Publication
(10) Pub. No.: US 2008/0088540 A1
(43) Pub. Date: Apr. 17, 2008

(54) Plasma display panel

(76) Inventor: Joong-Ho MOON, Suwon-si (KR)

Correspondence Address: ROBERT E. BUSHNELL, 1522 K STREET NW, SUITE 300, WASHINGTON, DC, 20005-1202, US

(21) Appl. No.: 11/907,392

(22) Filed: Oct. 11, 2007

(30) Foreign Application Priority Data
Oct. 11, 2006 (KR) 10-2006-0098932

(51) Int. Cl. G09G 3/28

(52) U.S. Cl. 345/65

(57) ABSTRACT

A plasma display panel includes a front substrate, a rear substrate facing the front substrate, and barrier ribs dividing a space between the front and the rear substrates to form discharge cells and channels between the discharge cells. Display electrodes are formed at the discharge cells in a second direction crossing the first direction. Main phosphor layers are formed within the discharge cells to classify the discharge cells into first through third color discharge cells depending upon the emitted colors thereof, and auxiliary phosphor layers are formed within the channels. The barrier ribs include a first barrier rib portion dividing the discharge cells in the first direction, and a second barrier rib portion dividing the discharge cells in the second direction and separating neighboring discharge cells in the first direction to form the channels. The main phosphor layers at the first through third color discharge cells and the auxiliary phosphor layers are colored with first through third colors, respectively.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 11 Oct. 2006 and there duly assigned Serial No. 10-2006-0098932.

### BACKGROUND OF THE INVENTION

1. Field of the Invention

The present invention relates to a plasma display panel with an enhanced image display capacity.

2. Description of Related Art

Generally, a plasma display panel (simply referred to as “PDP”) is a display device that excites phosphors with ultraviolet rays radiated from plasma formed through a gas discharge to generate visible light and display desired video images based thereon. It is possible to construct a high resolution wide screen PDP, which is spotlighted as a future flat panel display device.

The PDP is contemporarily constructed as a triode surface discharge structure, with a pair of electrodes formed on a surface of a front substrate, and address electrodes formed on a surface of a rear substrate spaced apart from the front substrate. The electrodes are located corresponding to respective discharge cells.

Several millions of unit discharge cells are arranged within the PDP in the form of a matrix. The discharge cells to be turned on or off are selected using the memory characteristic of wall charges, and the selected discharge cells are discharged to thereby display the desired images. With the selected discharge cells, the sustain discharge is made to excite the phosphors, and accordingly visible rays with inherent frequency bands are generated, thereby displaying the desired images.

Meanwhile, when the images are displayed by the PDP by selecting the discharge cells, visible rays generated from various kinds of external light sources are incident upon the PDP.

Some of the external light incident upon the PDP is reflected against the PDP and mixed with the displayed images. Specifically, as the structural components of a dielectric layer and a front substrate formed at the front side of the discharge cells are transparent, the external light reaches the phosphors formed at the discharge cells. As the phosphors produce a white color due to the material characteristic thereof, however, the external light incident upon the discharge cells is reflected against the phosphors to the outside of the PDP. In this process, the external light is mixed with the images displayed by the PDP, thereby deteriorating the practical image display capacity of the PDP.

### SUMMARY OF THE INVENTION

It is therefore an object of the present invention to provide an improved plasma display panel.

It is another object to provide a plasma display panel that prevents the reflection of external light.

According to one aspect of the present invention, a plasma display panel is constructed with a front substrate, a rear substrate facing the front substrate, and barrier ribs dividing a space between the front and rear substrates into discharge cells and channels between the discharge cells. Address electrodes are formed along the discharge cells in a first direction. Display electrodes are formed at the discharge cells in a second direction crossing the first direction. A dielectric layer covers the display electrodes. Main phosphor layers are formed within the discharge cells to classify the discharge cells into first through third color discharge cells depending upon the emitted colors thereof, and auxiliary phosphor layers are formed within the channels. The barrier rib includes a first barrier rib portion dividing the discharge cells in the first direction, and a second barrier rib portion dividing the discharge cells in the second direction and separating neighboring discharge cells in the first direction to form the channels. The main phosphor layers at the first through third color discharge cells and the auxiliary phosphor layers are colored with first through third colors, respectively.

The first to the third colors may be blue, green, and red, respectively.

The display electrodes may have first and second electrodes extending in the second direction parallel to each other and facing each other at the discharge cells with a discharge gap therebetween.

Based on a pair of neighboring discharge cells in the first direction, the second electrode may be placed directly over the channel formed between the pair of discharge cells, and the first electrodes may be placed around the second electrode, facing the second electrodes at the respective discharge cells.

The first electrode may be constructed with a bus electrode and transparent electrodes protruded from the bus electrode toward the second electrode.

The second electrode may be constructed with a bus electrode placed directly over the channel and elongated in the second direction, and transparent electrodes traversing the bus electrode and extending over the pair of neighboring discharge cells in the first direction.

According to another aspect of the present invention, a plasma display panel includes a front substrate, a rear substrate facing the front substrate, and barrier ribs dividing the space between the front and the rear substrates to form discharge cells and channels between the discharge cells. Address electrodes are formed along the discharge cells in a first direction. Display electrodes are formed at the discharge cells in a second direction crossing the first direction. A dielectric layer covers the display electrodes. Main phosphor layers are formed at the discharge cells. Auxiliary phosphor layers are formed at the channels. The barrier ribs each have a first barrier rib portion dividing the discharge cells in the first direction, and a second barrier rib portion dividing the discharge cells in the second direction and separating neighboring discharge cells in the first direction from each other to form the channels. The auxiliary phosphor layer is colored with a fourth color.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial exploded perspective view of a PDP constructed as an embodiment of the principles of the present invention;

FIG. 2 is a plan view of the PDP shown in FIG. 1, illustrating the positional relationship between the discharge cells and the display electrodes;

FIG. 3 is an electrode diagram of the PDP, illustrating the arrangement of the display electrodes; and

FIG. 4 is a cross-sectional view of the PDP taken along the IV-IV′ line of FIG. 2.

### DETAILED DESCRIPTION OF THE INVENTION

The present invention will be described more fully hereinafter with reference to the accompanying drawings, in which preferred embodiments of the invention are shown.

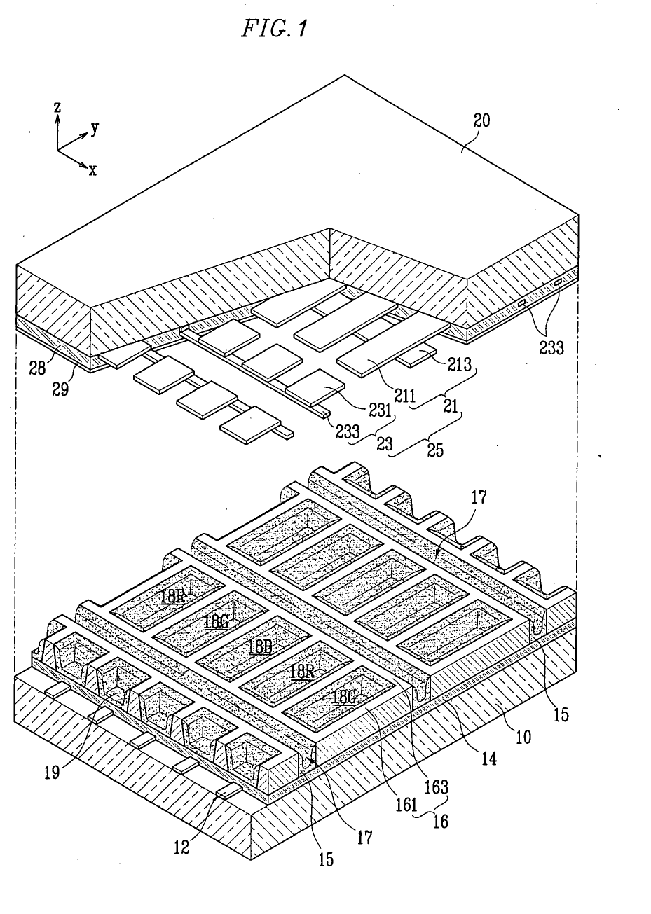

FIG. 1 is a partial exploded perspective view of a PDP constructed as an embodiment of the principles of the present invention.

With the PDP according to the embodiment of the present invention, front and rear substrates 20 and 10 face each other, and the space between front and rear substrates 20 and 10 is divided by barrier ribs 16 to thereby form discharge cells 18. Barrier ribs 16 are partially bordered by channels 17, that form exhaust passages between discharge cells 18.

Display and address electrodes 25 and 12 cross each other along discharge cells 18, and a dielectric layer 28 covers display electrodes 25 with a dielectric material.

Specifically, front substrate 20 is made from a transparent material based on reinforced glass to transmit visible light. The desired images are displayed on front substrate 20, due to the gas discharge generated in discharge cells 18.

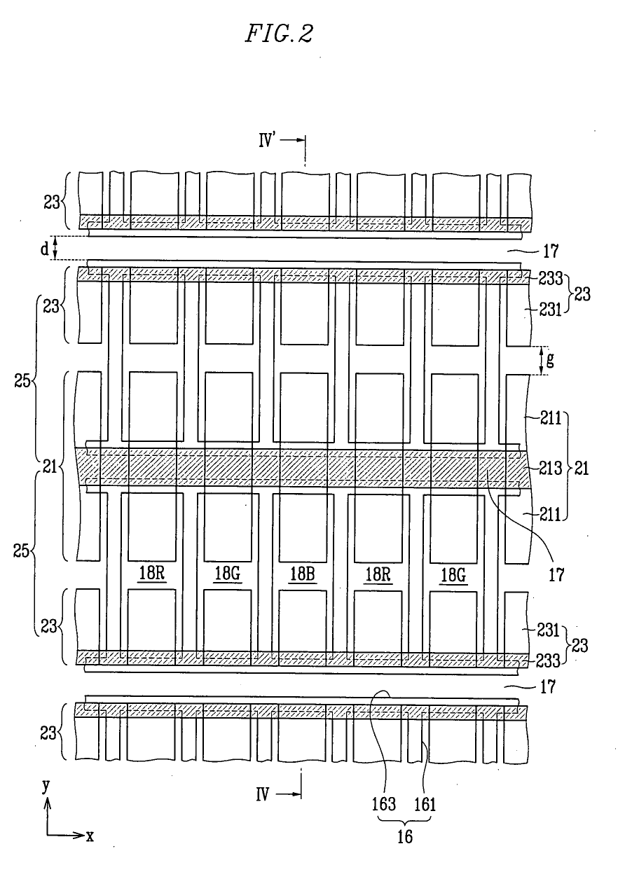

Display electrodes 25 are formed corresponding to the respective discharge cells 18. Each display electrode 25 is constructed with a first electrode (hereinafter referred to as a scan electrode) 23 and a second electrode (hereinafter referred to as a sustain electrode) 21. As shown in FIG. 2, scan and sustain electrodes 23 and 21 face each other at the corresponding discharge cells 18 with a discharge gap g. Scan electrodes 23 are operated in association with address electrodes 12 to select, i.e., to turn on a plurality of discharge cells 18 during a scan period, and sustain electrodes 21 are operated in association with scan electrodes 23 to induce the discharge within the selected discharge cells 18 during a sustain period.

Display electrodes 25 are covered by a dielectric layer 28 made from a dielectric material such as PbO, B₂O₃, and SiO₂. Dielectric layer 28 prevents display electrodes 25 from being damaged due to collisions with charged particles during the discharge.

A passivation film 29 is formed on dielectric layer 28. Passivation film 29 prevents dielectric layer 28 from being damaged due to direct collisions with charged particles. In addition, when colliding with the charged particles, passivation film 29 emits secondary electrons to thereby increase the discharge efficiency.

Address electrodes 12 are formed on a surface of rear substrate 10 facing front substrate 20. As shown in the drawing, address electrodes 12 traverse display electrodes 25, extending in a direction (in the y axis direction of the drawing) corresponding to the respective discharge cells 18, and being parallel to each other. Accordingly, with the overall structure of rear substrate 10, address electrodes 12 are wholly stripe-patterned. Address electrodes 12 are operated in association with scan electrodes 23 to select, i.e., to turn on a plurality of discharge cells 18.

Address electrodes 12 are covered by a dielectric layer 14. Barrier ribs 16 are formed on dielectric layer 14. Each barrier rib 16 is constructed with a first barrier rib portion 161 for dividing discharge cells 18 in a first direction (in the y axis direction of the drawing), and a second barrier rib portion 163 extending in a second direction (in the x axis direction of the drawing) and crossing first barrier rib portion 161. Second barrier rib portions 163 separate neighboring discharge cells in the first direction from each other to form channels 17 between the discharge cells.

Main phosphor layers 19 are formed within discharge cells 18 to emit visible rays with respective colors. Depending upon the colors emitted from the main phosphor layers 19, discharge cells 18 are classified into red, green, and blue discharge cells 18R, 18G, and 18B. Main phosphor layers 19 are colored with first through third colors, respectively.

Auxiliary phosphor layers 15 are formed within channels 17. Auxiliary phosphor layers 15 are colored with first through third colors like main phosphor layers 19, and are formed on the sidewalls of second barrier rib portions 163 and the bottom surface of channels 17.

Discharge cells 18 having phosphor layers 19 are internally filled with a mixed discharge gas of neon, xenon, etc.

Meanwhile, FIG. 2 is a plan view of the PDP shown in FIG. 1, illustrating the positional relationship between the discharge cells and the display electrodes.

As shown in FIG. 2, each barrier rib 16 is constructed with a first barrier rib portion 161 formed in a first direction (in the y axis direction of the drawing), and a second barrier rib portion 163 formed in a second direction (in the x axis direction of the drawing) crossing the first direction.

Second barrier rib portions 163 are elongated in the second direction (the x axis direction), and a pair of second barrier rib portions 163 dividing neighboring discharge cells 18 in the first direction (the y axis direction) are spaced apart from each other with a distance d so that channel 17 is formed between the pair of second barrier rib portions 163 in the second direction (the x axis direction).

Meanwhile, first barrier rib portion 161 interconnects the pair of second barrier rib portions 163 in the first direction to define discharge cells 18. Accordingly, discharge cells 18 are defined with a closed structure. With the closed discharge cell structure, channel 17 forms an exhaust passage between discharge cells 18. Consequently, even with the closed discharge cell structure, it becomes easy to inject the discharge gas into the discharge cells or to remove impurities.

Main phosphor layers 19 are formed within discharge cells 18. Depending upon the colors emitted from the main phosphor layers 19, discharge cells 18 are classified into red, green, and blue discharge cells 18R, 18G and 18B. A set of three-colored discharge cells form a pixel. Same-colored discharge cells are successively arranged in the first direction, and different-colored discharge cells are successively arranged in the second direction.

In this embodiment, main phosphor layers 19 are colored with first through third colors, respectively. That is, the main phosphor layers 19 formed at blue discharge cells 18B are colored with a first color, those formed at green discharge cells 18G with a second color, and those formed at red discharge cells 18R with a third color. The first to the third colors may be blue, green, and red such that they increase the color purity of the respective colored discharge cells and reduce the reflection of external light incident upon the discharge cells. Alternatively, main phosphor layers 19 may be colored with an achromatic color.

If main phosphor layer 19 is colored with an achromatic color and the external light is incident upon the discharge cell through front substrate 20, the achromatic color of main phosphor layer 19 does not reflect the external light, but absorbs it.

A auxiliary phosphor layer 15 is formed within channel 17. Auxiliary phosphor layer 15 is formed on the sidewalls of second barrier rib portions 163 and the bottom surface of channels 17. Furthermore, auxiliary phosphor layers 15 are colored with first through third colors, like main phosphor layers 19.

When auxiliary phosphor layer 15 and main phosphor layer 19 are colored with the same color, auxiliary phosphor layer 15 and main phosphor layer 19 may be simultaneously formed during the same process.

As auxiliary phosphor layers 15 formed at channels 17 are colored with first through third colors, auxiliary phosphor layers 15 do not appear to be white pursuant to the material characteristic of the phosphors. Consequently, the external light incident upon channels 17 is not reflected, but is absorbed by sub-phosphor layers 15 such that the images displayed by the PDP are not mixed with the external light, thereby enhancing the image display capacity.

Scan and sustain electrodes 23 and 21 of display electrodes 25 face each other over discharge cells 18 with a discharge gap g between scan and sustain electrodes 23 and 21.

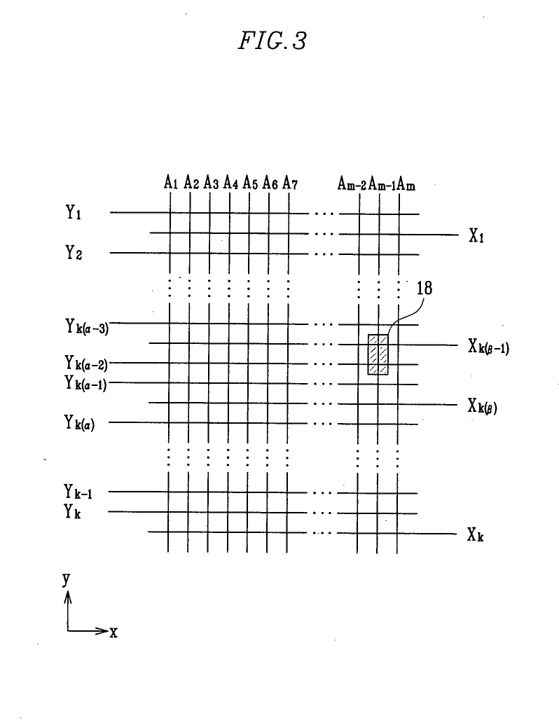

It is preferable that display electrodes 25 have an arrangement shown in FIG. 3. As shown in FIG. 3, scan electrodes Yk are arranged around sustain electrodes Xk.

Discharge cells 18 are formed at the crossed regions of sustain and scan electrodes Xk and Yk, and address electrodes Am. Sustain electrodes Xk are elongated in the second direction (in the x axis direction of the drawing), and scan electrodes Yk are spaced apart from sustain electrodes Xk with a distance g, such that they are elongated in the second direction and parallel to each other. Address electrodes Am are elongated in the first direction crossing the second direction (in the y axis direction of the drawing), thereby forming discharge cells 18.

Sustain electrode Xk is not formed at the respective discharge cells, but is shared by the pair of neighboring discharge cells in the first direction (in the y axis direction of the drawing). A pair of scan electrodes Yk are formed around sustain electrode Xk.

Depending upon the above arrangement, sustain electrodes 21 are overlying in alignment with channels 17, and are elongated in the second direction along which channel 17 extends.

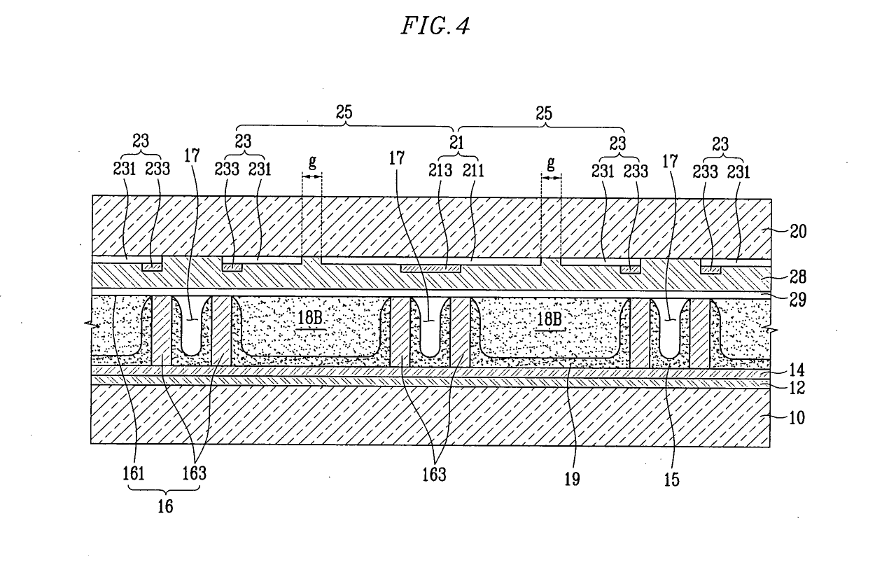

Sustain electrode 21 is preferably constructed with a combination of a bus electrode 213 and transparent electrodes 211. Bus electrode 213 is placed directly over channel 17, and is elongated in the second direction. Consequently, as shown in FIG. 4, the top surface of channel 17 is shadowed by bus electrode 213 so that the reflection of external light made at channel 17 is prevented by bus electrode 213.

Transparent electrodes 211 traverse bus electrode 213 such that they extend over the pair of neighboring discharge cells in the first direction.

Scan electrodes 23 are arranged around sustain electrode 21. Scan electrode 23 is constructed with a combination of a bus electrode 233, and transparent electrodes 231 protrude from bus electrode 233 toward scan electrode 23.

Accordingly, transparent electrodes 211 and 231 are placed over the discharge cells with a discharge gap g between transparent electrodes 211 and 231.

It is described above that main phosphor layer 19 and auxiliary phosphor layer 15 are colored with first through third colors, respectively.

Alternatively, auxiliary phosphor layer 15 may be colored with a fourth color, which is preferably an achromatic color. External light is incident upon auxiliary phosphor layer 15 formed within channel 17. When auxiliary phosphor layer 15 is colored with the fourth achromatic color, the external light incident upon channel 17 is absorbed by auxiliary phosphor layer 15, thereby reducing the reflection of external light.

Alternatively, main phosphor layer 19 may be colored with a fifth color, which is preferably the same as the fourth color. If the fourth color is gray, the fifth color is also established to be gray. In this way, when main phosphor layer 19 and auxiliary phosphor layer 15 are colored with the same color, they may be formed simultaneously.

The reflection of external light is reduced by forming the colored auxiliary phosphor layers at the channels, thereby enhancing the image display capacity.

Furthermore, with the formation of display electrodes, the sustain electrodes are formed directly over the channels so that the top surface of the channels is shadowed by the electrodes, thereby decreasing the reflection of external light made at the channels.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. A plasma display panel, comprising:
a front substrate;
a rear substrate facing the front substrate;
barrier ribs dividing a space between the front and rear substrates to form discharge cells and channels located between the discharge cells;
address electrodes formed along the discharge cells in a first direction;
display electrodes formed at the discharge cells in a second direction crossing the first direction;
a dielectric layer covering the display electrodes;
main phosphor layers formed in the discharge cells to classify the discharge cells into first through third color discharge cells in dependence upon the emitted colors thereof; and
auxiliary phosphor layers formed in the channels,
the barrier ribs comprising a first barrier rib portion dividing the discharge cells in the first direction, and a second barrier rib portion dividing the discharge cells in the second direction and spacing neighboring discharge cells in the first direction from each other to form the channels, and
the main phosphor layers in the first through third color discharge cells and the auxiliary phosphor layers being colored with first, second and third colors, respectively.

2. The plasma display panel of claim 1, with the first through third colors being blue, green, and red, respectively.

3. The plasma display panel of claim 1, with the display electrodes comprising first and second electrodes extending in the second direction, being parallel to each other and facing each other at the discharge cells with a discharge gap therebetween.

4. The plasma display panel of claim 3, with, based on a pair of neighboring discharge cells in the first direction, the second electrodes being placed directly over the channel formed between the pair of discharge cells, and the first electrodes being placed around the second electrodes and facing the second electrodes at the respective discharge cells.

5. The plasma display panel of claim 4, with the first electrode comprising:
a bus electrode, and
transparent electrodes protruded from the bus electrode toward the second electrode.

6. The plasma display panel of claim 4, with the second electrode comprising:
a bus electrode placed directly over the channel and elongated in the second direction, and
transparent electrodes traversing the bus electrode and extending over the pair of neighboring discharge cells in the first direction.

7. A plasma display panel, comprising:
a front substrate;
a rear substrate facing the front substrate;
barrier ribs dividing a space between the front and rear substrates to form discharge cells and channels located between the discharge cells;
address electrodes formed along the discharge cells in a first direction;
display electrodes formed at the discharge cells in a second direction crossing the first direction;
a dielectric layer covering the display electrodes;
main phosphor layers formed within the discharge cells; and
auxiliary phosphor layers formed within the channels,
the barrier ribs comprising a first barrier rib portion dividing the discharge cells in the first direction, and a second barrier rib portion dividing the discharge cells in the second direction and separating neighboring discharge cells in the first direction to form the channels, and
the auxiliary phosphor layer being colored with a fourth color.

8. The plasma display panel of claim 7, with the display electrodes extending in the second direction parallel to each other, and comprising first and second electrodes facing each other at the discharge cells with a discharge gap therebetween.

9. The plasma display panel of claim 8, with, based on a pair of neighboring discharge cells in the first direction, the second electrodes being placed directly over the channel formed between the pair of discharge cells, and the first electrodes being placed around the second electrodes and facing the second electrodes at the respective discharge cells.

10. The plasma display panel of claim 9, with the first electrode comprising:
a bus electrode, and
transparent electrodes protruding from the bus electrode toward the second electrode.

11. The plasma display panel of claim 9, with the second electrode comprising:
a bus electrode placed directly over the channel and elongated in the second direction, and
transparent electrodes traversing the bus electrode and extending over the pair of neighboring discharge cells in the first direction.

12. The plasma display panel of claim 7, with the main phosphor layers being colored with first, second and third colors, respectively.

13. The plasma display panel of claim 7, with the main phosphor layers being colored with a fifth color.

14. The plasma display panel of claim 13, with the fifth and fourth colors being a same color.

15. The plasma display panel of claim 7, with the fourth color being an achromatic color.

16. The plasma display panel of claim 15, with the main phosphor layers being colored with a fifth color.

17. The plasma display panel of claim 16, with the fifth and fourth colors being a same color.

18. The plasma display panel of claim 17, with the fifth color being an achromatic color.
